(19) United States
(12) Patent Application Publication
(10) Pub. No.: US 2025/0147533 A1
(43) Pub. Date: May 8, 2025

(54) LOW-DROPOUT REGULATOR AND OPERATION METHOD THEREOF

(71) Applicant: Realtek Semiconductor Corp., HsinChu (TW)

(72) Inventors: Yung-Chun Chang, HsinChu (TW); Han-Chang Kang, HsinChu (TW)

(73) Assignee: Realtek Semiconductor Corp., HsinChu (TW)

(21) Appl. No.: 18/817,196

(22) Filed: Aug. 27, 2024

(30) Foreign Application Priority Data
Nov. 3, 2023 (TW) 112142380

(51) Int. Cl. G05F 1/575

(52) U.S. Cl. CPC G05F 1/575

(57) ABSTRACT

A low-dropout (LDO) regulator and operation method thereof are provided. The LDO regulator may include a reference voltage generation circuit, an operational amplifier, a transistor and a multiphase configuration switching control circuit. The operation method may include: performing a first configuring operation to enable a first dedicated current path corresponding to a first phase to allow a target reference voltage used in LDO regulating mode to reach a first predetermined range after the first configuring operation is performed; performing a second configuring operation to enable a second dedicated current path corresponding to a second phase to allow the target reference voltage to reach a second predetermined range after the second configuring operation is performed; and performing a third configuring operation to allow the target reference voltage to be used as a reference voltage input into the operational amplifier in the LDO regulating mode after the third configuring operation is performed.

### BACKGROUND OF THE INVENTION

### 1. Field of the Invention

The present invention relates to circuit design, and more particularly, to a low-dropout (LDO) voltage regulator (or “the LDO regulator”) and an operation method thereof.

### 2. Description of the Prior Art

According to related technologies, a voltage regulator such as a conventional LDO regulator may be installed in an electronic device to provide a source voltage to generate a steady (or stable, uniform) voltage. For example, the source voltage may contain noise, and certain circuits in the electronic device may use the steady voltage to avoid being affected by the noise. When it is not needed to use these circuits, the electronic device may temporarily turn off the conventional LDO regulator to save power. When it is needed to use these circuits, the electronic device may turn on the conventional LDO regulator. The time it takes for the conventional LDO regulator to reach the steady state may be quite long. One or more suggestions may be proposed in the related art to try solving this problem, but do not actually solve this problem. For example, the average time for the conventional LDO regulator to reach the steady state may exceed 10 microseconds (μs), and the electronic device may need to wait longer, such as 20 milliseconds (ms) to avoid any error caused by any variation in the time to reach the steady state, which may be too long for the requirements of high-speed operations. Therefore, a novel method and associated architecture are needed for solving the problems without introducing any side effect or in a way that is less likely to introduce a side effect.

### SUMMARY OF THE INVENTION

It is an objective of the present invention to provide a LDO regulator and an operation method thereof, in order to solve the above-mentioned problems and improve the overall performance.

At least one embodiment of the present invention provides a LDO regulator. The LDO regulator may comprise a reference voltage generation circuit, an operational amplifier coupled to the reference voltage generation circuit, and a transistor coupled to the operational amplifier, as well as a multiphase configuration switching control circuit that is coupled to the reference voltage generation circuit, the operational amplifier and the transistor. The reference voltage generation circuit may be arranged to generate at least one reference voltage; the operational amplifier may be arranged to control an output voltage of the LDO regulator via negative feedback in a LDO regulating mode of the LDO regulator; the transistor may be arranged to generate the output voltage of the LDO regulator under control of the operational amplifier in the LDO regulating mode, for further use; and the multiphase configuration switching control circuit may be arranged to perform multiphase configuration switching control to perform multiple configuring operations on circuit architecture of the LDO regulator. For example, the multiphase configuration switching control circuit performs a first configuring operation on the circuit architecture of the LDO regulator to enable a first dedicated current path corresponding to a first phase, to allow a target reference voltage used in the LDO regulating mode to reach a first predetermined range after the first configuring operation is performed; the multiphase configuration switching control circuit performs a second configuring operation on the circuit architecture of the LDO regulator to enable a second dedicated current path corresponding to a second phase, to allow the target reference voltage to reach a second predetermined range after the second configuring operation is performed; and the multiphase configuration switching control circuit performs a third configuring operation on the circuit architecture of the LDO regulator, to allow the target reference voltage to be used as a reference voltage input into the operational amplifier in the LDO regulating mode after the third configuring operation is performed.

At least one embodiment of the present invention provides an operation method that is applicable to the above-mentioned LDO regulator. The operation method may comprise: utilizing the multiphase configuration switching control circuit to perform the first configuring operation on the circuit architecture of the LDO regulator to enable the first dedicated current path corresponding to the first phase, to allow a target reference voltage used in the LDO regulating mode to reach the first predetermined range after the first configuring operation is performed; utilizing the multiphase configuration switching control circuit to perform the second configuring operation on the circuit architecture of the LDO regulator to enable the second dedicated current path corresponding to the second phase, to allow the target reference voltage to reach the second predetermined range after the second configuring operation is performed; and utilizing the multiphase configuration switching control circuit to perform the third configuring operation on the circuit architecture of the LDO regulator, to allow the target reference voltage to be used as the reference voltage input into the operational amplifier in the LDO regulating mode after the third configuring operation is performed.

It is an advantage of the present invention that, the LDO regulator and the operation method thereof in present invention can perform reference voltage preliminary setting (or the preliminary setting of the reference voltage) through multiphase control, and more particularly, accelerate the reference voltage preliminary setting to make the target reference voltage quickly reaches a predetermined voltage level. In addition, the LDO regulator and the operation method thereof in the present invention can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a LDO regulator according to an embodiment of the present invention.

FIG. 2 is a diagram of a LDO regulator according to another embodiment of the present invention.

FIG. 3A illustrates a configuration of the circuit architecture shown in FIG. 1 in a first phase according to an embodiment of the present invention.

FIG. 3B illustrates a configuration of the circuit architecture shown in FIG. 2 in the first phase according to an embodiment of the present invention.

FIG. 4A illustrates a configuration of the circuit architecture shown in FIG. 1 in a second phase according to an embodiment of the present invention.

FIG. 4B illustrates a configuration of the circuit architecture shown in FIG. 2 in the second phase according to an embodiment of the present invention.

FIG. 5A illustrates a configuration of the circuit architecture shown in FIG. 1 in a third phase according to an embodiment of the present invention.

FIG. 5B illustrates a configuration of the circuit architecture shown in FIG. 2 in the third phase according to an embodiment of the present invention.

FIG. 6 illustrates a timing diagram of some associated signals according to an embodiment of the present invention.

FIG. 7 illustrates a working flow of an operation method of a LDO regulator according to an embodiment of the present invention.

### DETAILED DESCRIPTION

Multiple embodiments of the present invention provide a LDO regulator that can perform reference voltage preliminary setting through multiphase control, to make the LDO regulator reach the steady state thereof immediately after being turned on, to allow an electronic device adopting the LDO regulator to immediately use the LDO regulator, in order to improve overall performance. For example, an output voltage of the LDO regulator can quickly reach a predetermined voltage level to allow at least one internal circuit (e.g., one or more internal circuits) of the electronic device to operate according to the output voltage that has reached the predetermined voltage level. When it is not needed to use the aforementioned at least one internal circuit, the electronic device can temporarily turn off the LDO regulator to save power. When it is needed to use the aforementioned at least one internal circuit, the electronic device can turn on the LDO regulator again. Similarly, the LDO regulator can reach the steady state immediately after being turned on again, allowing the electronic device (or the aforementioned at least one internal circuit thereof) to immediately use the LDO regulator, in order to improve the overall performance.

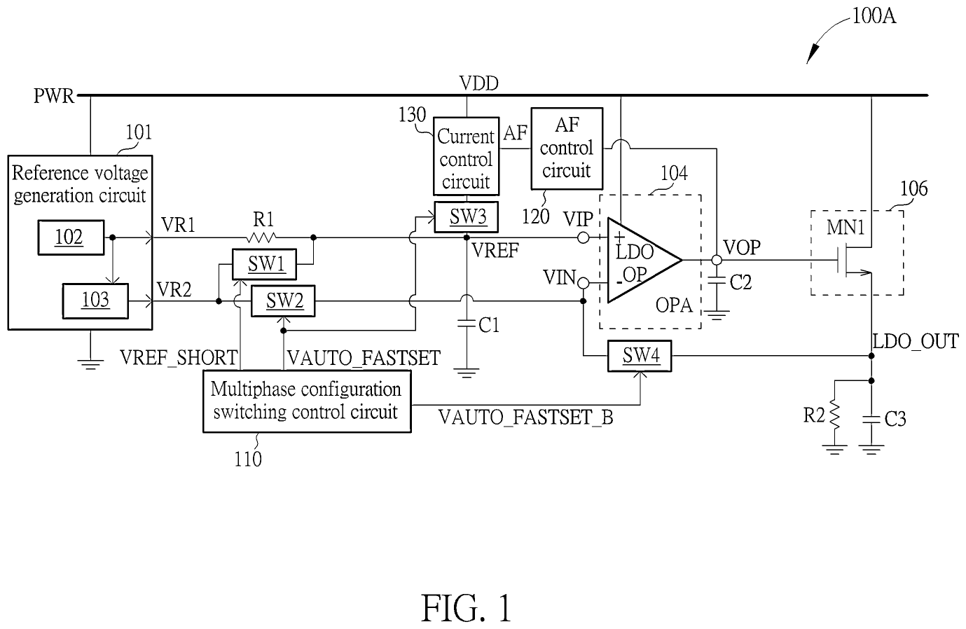

FIG. 1 is a diagram of a LDO regulator 100A according to an embodiment of the present invention, where the LDO regulator 100A may be taken as an example of the above-mentioned LDO regulator of the present invention. The LDO regulator 100A may comprise a reference voltage generation circuit 101, an operational amplifier 104 (labeled “OPA” for brevity), a transistor 106, a multiphase configuration switching control circuit 110, an automatic fast-set (AF) control circuit 120 (labeled “AF control circuit” for brevity), a current control circuit 130, multiple resistors {R1, R2}, multiple capacitors {C1, C2, C3}, multiple switch circuits {SW1, SW2, SW3, SW4} and a power line PWR arranged to provide a power supply voltage VDD, and these components listed above may be coupled to each other as shown in FIG. 1, where the reference voltage generation circuit 101 may comprise a reference voltage generator 102 and a reference voltage converter 103, the transistor 106 may be implemented by way of a Metal Oxide Semiconductor Field Effect Transistor (MOSFET) such as an N-type MOSFET MN1, and among multiple input terminals of the operational amplifier 104, a first input terminal and a second input terminal for receiving the input voltages VIP and VIN may represent a positive input terminal and a negative input terminal (respectively labeled “+” and “−” in the triangle “LDO OP” representing the operational amplifier for brevity), respectively, but the present invention is not limited thereto. According to some embodiments, the circuit architecture shown in FIG. 1 may vary.

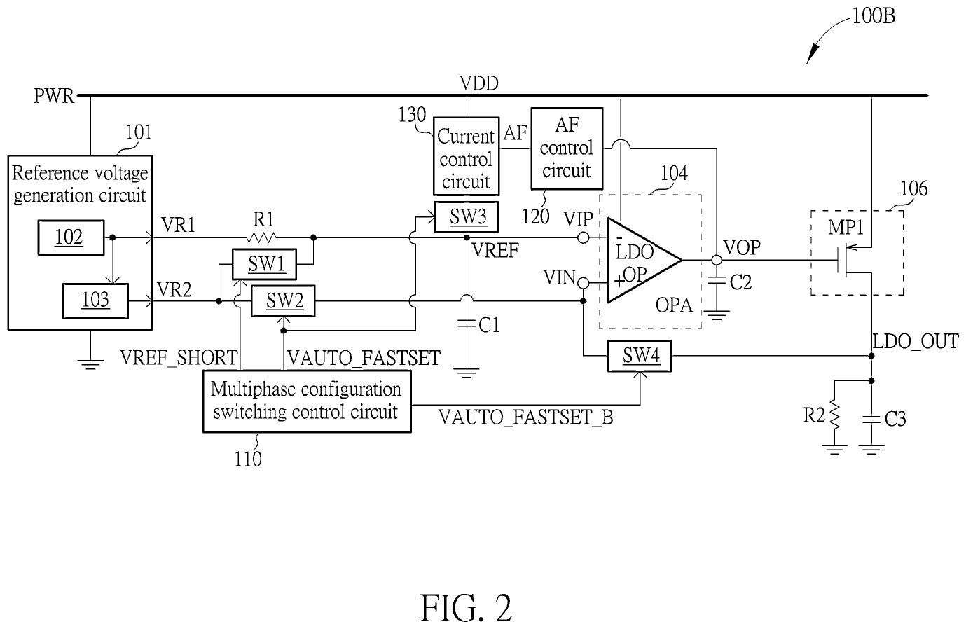

FIG. 2 is a diagram of a LDO regulator 100B according to another embodiment of the present invention, where the LDO regulator 100B may be taken as an example of the above-mentioned LDO regulator of the present invention. The LDO regulator 100B may comprise the reference voltage generation circuit 101, the operational amplifier 104 (labeled “OPA” for brevity), the transistor 106, the multiphase configuration switching control circuit 110, the automatic fast-set control circuit 120 (labeled “AF control circuit” for brevity), the current control circuit 130, the multiple resistors {R1, R2}, the multiple capacitors {C1, C2, C3}, the multiple switch circuits {SW1, SW2, SW3, SW4} and the power line PWR, and these components listed above may be coupled to each other as shown in FIG. 2, where the transistor 106 may be implemented by way of the MOSFET such as a P-type MOSFET MP1, and among the multiple input terminals of the operational amplifier 104, the first input terminal and the second input terminal for receiving the input voltages VIP and VIN may represent the negative input terminal and the positive input terminal (respectively labeled “−” and “+” in the triangle “LDO OP” representing the operational amplifier for brevity), respectively, but the present invention is not limited thereto. According to some embodiments, the circuit architecture shown in FIG. 2 may vary.

As shown in any figure among FIG. 1 and FIG. 2, the LDO regulator (e.g., the LDO regulators 100A or 100B) of the present invention may utilize the reference voltage generation circuit 101 to generate at least one reference voltage, utilize the operational amplifier 104 to control the output voltage LDO_OUT of the LDO regulator via negative feedback in a LDO regulating mode of the LDO regulator, and utilize the transistor 106 to generate the output voltage LDO_OUT of the LDO regulator under control of the operational amplifier 104 in the LDO regulating mode, for further use. More particularly, the LDO regulator of the present invention (e.g., the LDO regulators 100A or 100B) may utilize the multiphase configuration switching control circuit 110 to perform multiphase configuration switching control to perform multiple configuring operations on the circuit architecture of the LDO regulator, such as the circuit architecture shown in FIG. 1 or FIG. 2. For example, the associated operations regarding the multiphase configuration switching control may comprise:
(1) the multiphase configuration switching control circuit 110 may perform a first configuring operation on the circuit architecture of the LDO regulator to enable a first dedicated current path (e.g., the current path starting from the power line PWR, passing through the current control circuit 130 and the switch circuit SW3 and reaching the upper terminal of the capacitor C1) corresponding to a phase Phase1, to allow a target reference voltage VREF used in the LDO regulating mode to reach a first predetermined range after the first configuring operation is performed;
(2) the multiphase configuration switching control circuit 110 may perform a second configuring operation on the circuit architecture of the LDO regulator to enable a second dedicated current path (e.g., the current path starting from reference voltage converter 103, passing through the switch circuit SW1 and reaching the upper terminal of the capacitor C1) corresponding to a phase Phase2, to allow the target reference voltage VREF to reach a second predetermined range after the second configuring operation is performed; and
(3) the multiphase configuration switching control circuit 110 may perform a third configuring operation on the circuit architecture of the LDO regulator, to allow the target reference voltage VREF to be used as the reference voltage VREF input into the operational amplifier 104 in the LDO regulating mode after the third configuring operation is performed;
but the present invention is not limited thereto. According to some embodiments, the associated operations regarding the multiphase configuration switching control may vary.

In addition, reaching the first predetermined range may comprise exceeding a voltage level VB, and reaching the second predetermined range may comprise approaching a voltage level VA, where the voltage level VB is less than the voltage level VA, and more particularly, slightly less than less than the voltage level VA. For example, the aforementioned at least one reference voltage may comprise a reference voltage VR1 equal to the voltage level VA and a reference voltage VR2 equal to the voltage level VB. The reference voltage generator 102 may generate the reference voltage VR1, and the reference voltage converter 103 may perform voltage conversion on the reference voltage VR1 to generate the reference voltage VR2, and control the difference (VR1−VR2) between the reference voltage VR1 and the reference voltage VR2 to be equal to a predetermined difference (VA−VB), that is, the difference (VA−VB) between the voltage level VA and the voltage level VB, for the multiphase configuration switching control circuit 110 to accelerate the setting of the target reference voltage VREF.

Additionally, the multiphase configuration switching control circuit 110 may generate multiple control signals {VREF_SHORT, VAUTO_FASTSET, VAUTO_FASTSET_B} to control the switch circuits {SW1, SW2, SW3, SW4} to perform any configuring operation among the multiple configuring operations (e.g., the first configuring operation, the second configuring operation and the third configuring operation) on the circuit architecture of the LDO regulator, where the control signal VAUTO_FASTSET_B may represent the inverted signal of the control signal VAUTO_FASTSET. As shown in any figure of FIG. 1 and FIG. 2, among the multiple input terminals of the operational amplifier 104, the first input terminal for receiving the input voltage VIP may be coupled to the output terminal of the reference voltage generator 102 through the resistor R1, and after performing the second configuring operation or the third configuring operation, the second input terminal for receiving the input voltage VIN may be coupled to a first terminal of the transistor 106 through a negative feedback path (on which the switch circuit SW4 is installed), for example, the first terminal of the transistor 106 may represent the lower terminal among multiple terminals of the transistor 106 that is used for outputting the output voltage LDO_OUT of the LDO regulator. Taking the circuit architecture shown in FIG. 1 as an example, the second input terminal for receiving the input voltage VIN may be coupled to the source terminal of the N-type MOSFET MN1 through the negative feedback path. Taking the circuit architecture shown in FIG. 2 as an example, the second input terminal for receiving the input voltage VIN may be coupled to the drain terminal of the P-type MOSFET MP1 through the negative feedback path.

In the circuit architecture of the LDO regulator, such as the circuit architecture shown in FIG. 1 or FIG. 2, the reference voltage generator 102 can be implemented by way of a bandgap reference voltage generation circuit, etc., the reference voltage converter 103 can be implemented by way of a voltage dividing resistor, a diode-connected transistor such as a diode-connected MOSFET (e.g., a MOSFET with the gate terminal and the drain terminal thereof being connected to each other), etc., the multiphase configuration switching control circuit 110 and the automatic fast-set control circuit 120 can be implemented by way of logic circuits, etc., the current control circuit 130 can be implemented by way of various transistors such as MOSFETs (e.g., N-type MOSFET and/or P-type MOSFET), resistors with fixed resistance values, variable resistors, etc., and the switch circuits {SW1, SW2, SW3, SW4} can be implemented by way of various transistors such as MOSFETs (e.g., N-type MOSFETs and/or P-type MOSFETs), but the present invention is not limited thereto.

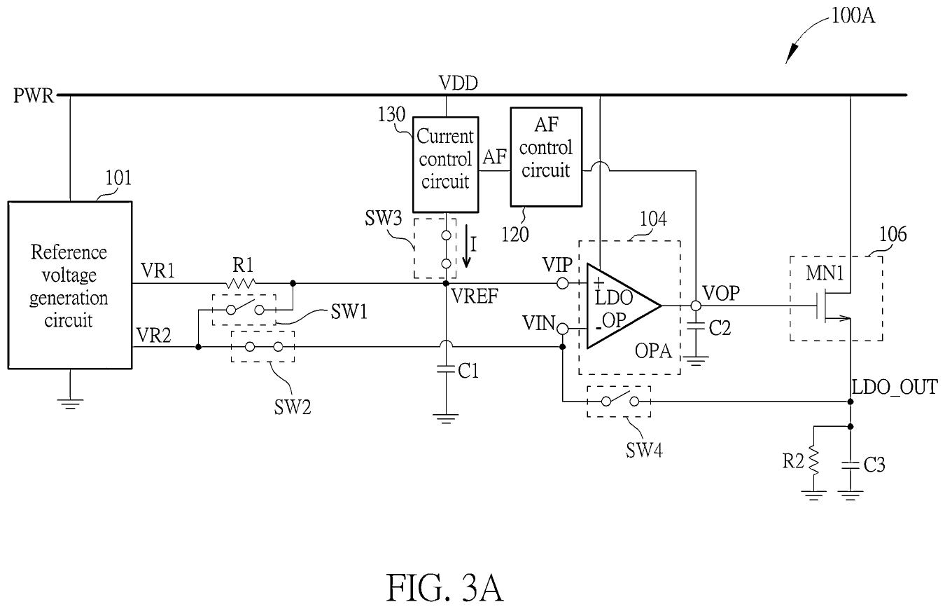

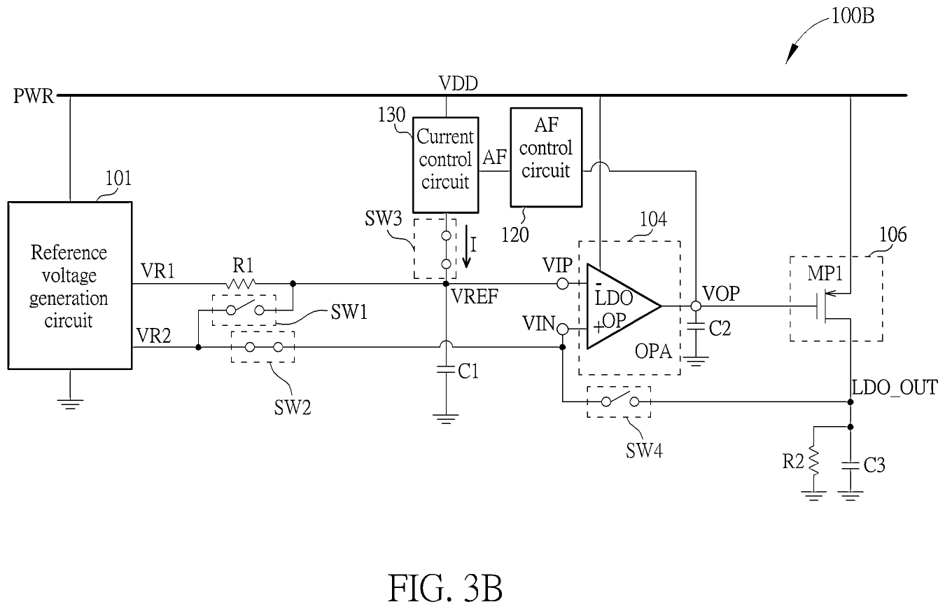

FIG. 3A illustrates a configuration of the circuit architecture shown in FIG. 1 in the phase Phase1 according to an embodiment of the present invention. Under the control of the multiphase configuration switching control circuit 110 shown in FIG. 1 (or the control signals {VREF_SHORT, VAUTO_FASTSET, VAUTO_FASTSET_B} generated and output thereby), the switch circuits {SW1, SW2, SW3, SW4} may operate as shown in FIG. 3A, to allow the multiphase configuration switching control circuit 110 to perform the first configuring operation on the circuit architecture of the LDO regulator 100A. For example, the multiphase configuration switching control circuit 110 may turn on the switch circuits SW2 and SW3 and turn off the switch circuits SW1 and SW4.

FIG. 3B illustrates a configuration of the circuit architecture shown in FIG. 2 in the phase Phase1 according to an embodiment of the present invention. Under the control of the multiphase configuration switching control circuit 110 shown in FIG. 2 (or the control signals {VREF_SHORT, VAUTO_FASTSET, VAUTO_FASTSET_B} generated and output thereby), the switch circuits {SW1, SW2, SW3, SW4} may operate as shown in FIG. 3B, to allow the multiphase configuration switching control circuit 110 to perform the first configuring operation on the circuit architecture of the LDO regulator 100B. For example, the multiphase configuration switching control circuit 110 may turn on the switch circuits SW2 and SW3 and turn off the switch circuits SW1 and SW4.

As shown in any figure among FIG. 3A and FIG. 3B, performing the first configuring operation may comprise:
(1) enabling the first dedicated current path (e.g., the current path starting from the power line PWR, passing through the current control circuit 130 and the switch circuit SW3 and reaching the upper terminal of the capacitor C1) corresponding to the phase Phase1 to perform a first preliminary setting operation on the target reference voltage VREF according to the power supply voltage VDD, for accelerating the target reference voltage VREF reaching the first predetermined range;
(2) coupling the multiple input terminals (e.g., the first input terminal and the second input terminal for receiving the input voltages VIP and VIN, respectively) of the operational amplifier 104 to the target reference voltage VREF and the reference voltage VR2, respectively, to make the operational amplifier 104 act as a comparator, for comparing the target reference voltage VREF and the reference voltage VR2;
(3) disconnecting the negative feedback path between the second input terminal (e.g., the second input terminal for receiving the input voltage VIN) of the operational amplifier 104 and the first terminal (e.g., the lower terminal for outputting the output voltage LDO_OUT of the LDO regulator) of the transistor 106 to disable the negative feedback path used in the LDO regulating mode;
where in the LDO regulating mode, the first terminal of the transistor 106 is arranged to output the output voltage LDO_OUT of the LDO regulator, but the present invention is not limited thereto. In addition, the automatic fast-set control circuit 120 may be coupled to an output terminal (e.g., the output terminal for generating the output voltage VOP) of the operational amplifier 104, and may receive a comparison result of the target reference voltage VREF and the reference voltage VR2 from the operational amplifier 104, to generate a control signal AF according to the comparison result. The current control circuit 130 may be coupled to the automatic fast-set control circuit 120, and may control the current I on the first dedicated current path according to the control signal AF, for accelerating the target reference voltage VREF reaching the first predetermined range.

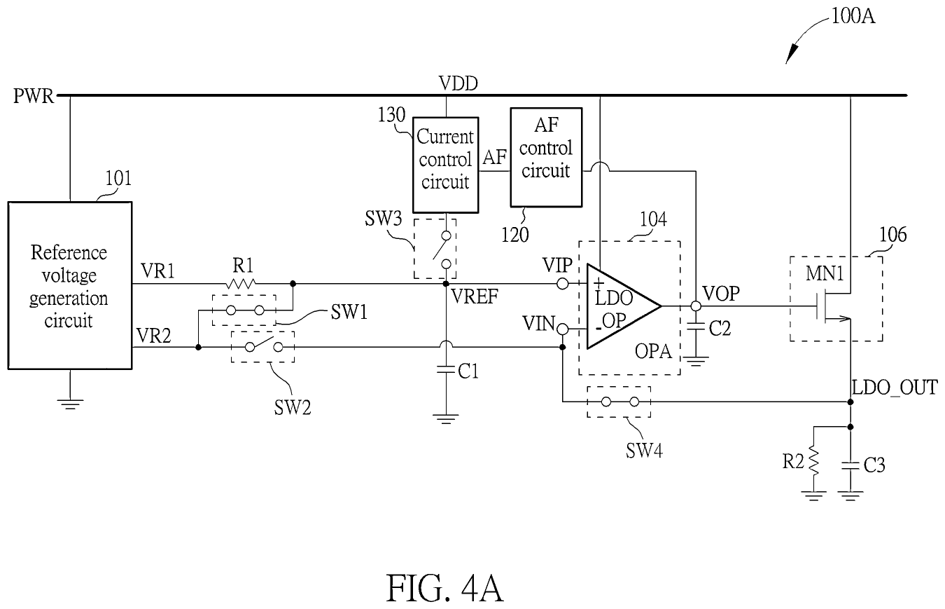

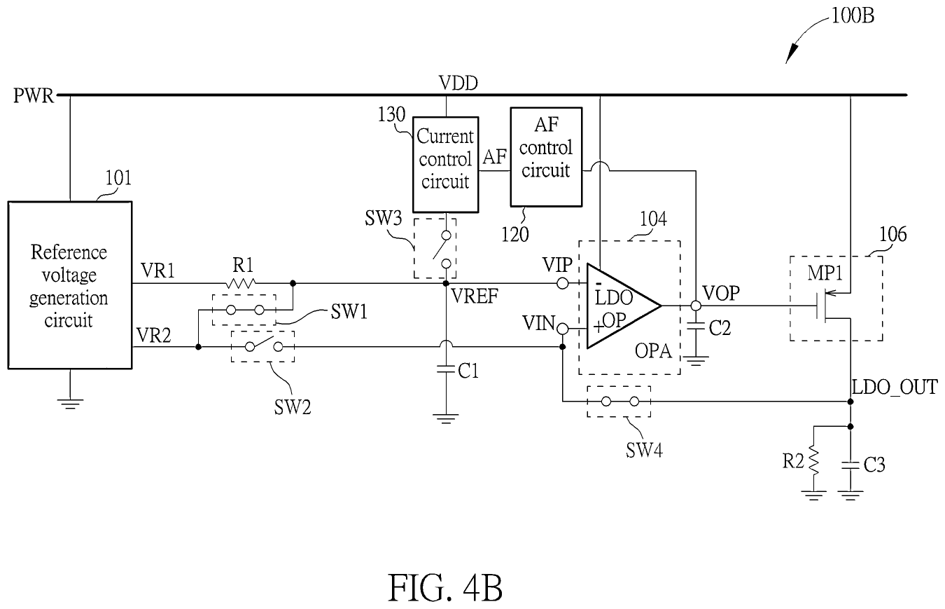

FIG. 4A illustrates a configuration of the circuit architecture shown in FIG. 1 in the phase Phase2 according to an embodiment of the present invention. Under the control of the multiphase configuration switching control circuit 110 shown in FIG. 1 (or the control signals {VREF_SHORT, VAUTO_FASTSET, VAUTO_FASTSET_B} generated and output thereby), the switch circuits {SW1, SW2, SW3, SW4} may operate as shown in FIG. 4A, to allow the multiphase configuration switching control circuit 110 to perform the second configuring operation on the circuit architecture of the LDO regulator 100A. For example, the multiphase configuration switching control circuit 110 may turn on the switch circuits SW1 and SW4 and turn off the switch circuits SW2 and SW3.

FIG. 4B illustrates a configuration of the circuit architecture shown in FIG. 2 in the phase Phase2 according to an embodiment of the present invention. Under the control of the multiphase configuration switching control circuit 110 shown in FIG. 2 (or the control signals {VREF_SHORT, VAUTO_FASTSET, VAUTO_FASTSET_B} generated and output thereby), the switch circuits {SW1, SW2, SW3, SW4} may operate as shown in FIG. 4B, to allow the multiphase configuration switching control circuit 110 to perform the second configuring operation on the circuit architecture of the LDO regulator 100B. For example, the multiphase configuration switching control circuit 110 may turn on the switch circuits SW1 and SW4 and turn off the switch circuits SW2 and SW3.

As shown in any figure among FIG. 4A and FIG. 4B, performing the second configuring operation may comprise:
(1) stopping coupling the second input terminal (e.g., the second input terminal for receiving the input voltage VIN) of the operational amplifier 104 to the reference voltage VR2, and coupling (or starting coupling) the second input terminal of the operational amplifier to the first terminal (e.g., the lower terminal for outputting the output voltage LDO_OUT of the LDO regulator) of the transistor 106, to enable the negative feedback path used in the LDO regulating mode;
(2) disabling the first dedicated current path (e.g., the current path starting from the power line PWR, passing through the current control circuit 130 and the switch circuit SW3 and reaching the upper terminal of the capacitor C1) corresponding to the phase Phase1, where the first dedicated current path may be coupled between the power line PWR and the first input terminal (e.g., the first input terminal for receiving the input voltage VIP) of the operational amplifier 104 in the phase Phase1, and may be no longer coupled between the power line and the first input terminal of the operational amplifier 104 in the phase Phase2; and
(3) enabling the second dedicated current path (e.g., the current path starting from reference voltage converter 103, passing through the switch circuit SW1 and reaching the upper terminal of the capacitor C1) corresponding to the phase Phase2 to make the first input terminal (e.g., the first input terminal for receiving the input voltage VIP) of the operational amplifier 104 be coupled to the reference voltage VR2, to forcibly set the target reference voltage VREF to be equal to the reference voltage VR2, for reducing any deviation of the target reference voltage VREF generated in the phase Phase1 with respect to the second predetermined range to accelerate the target reference voltage VREF reaching the second predetermined range;
but the present invention is not limited thereto. In addition, the time of enabling the second dedicated current path corresponding to the phase Phase2 may comprise at least one portion (e.g., a portion or all) of the phase Phase2. For example, the time of enabling the second dedicated current path corresponding to the phase Phase2 may comprise a portion of the phase Phase2, and more particularly, reach a predetermined time length (e.g., the maximum reaction time of the switch circuit SW1). For another example, the time of enabling the second dedicated current path corresponding to the phase Phase2 may comprise all (or the entirety) of the phase Phase2.

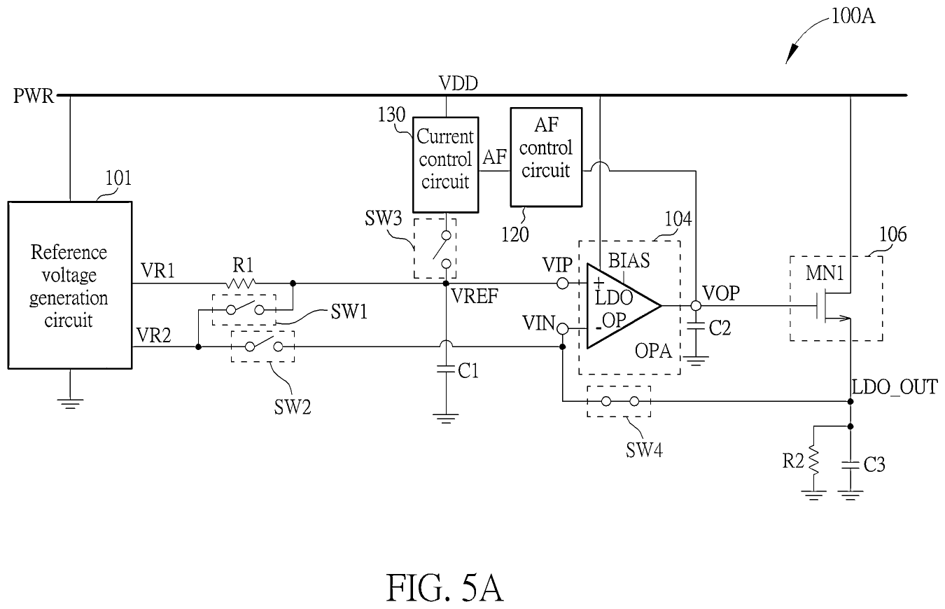

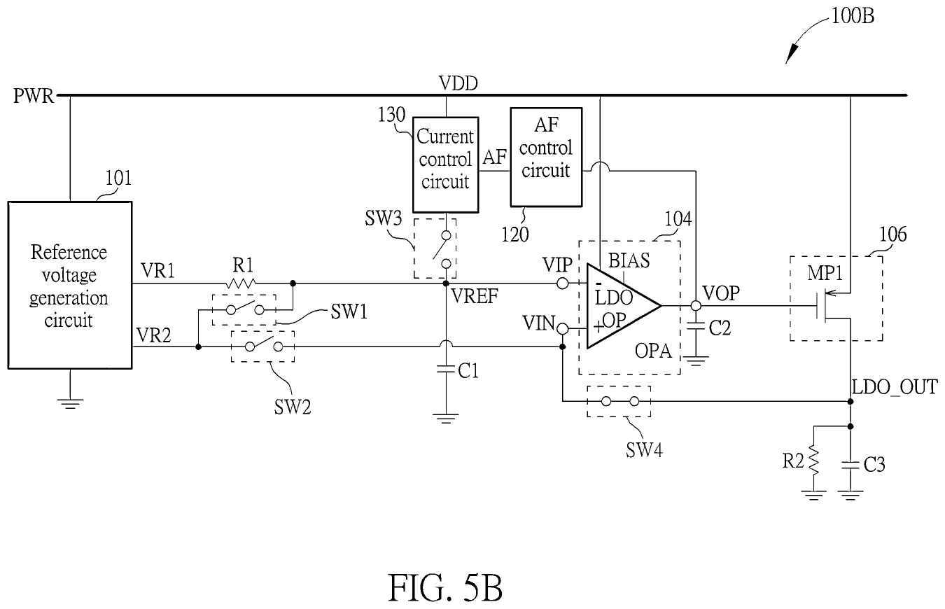

FIG. 5A illustrates a configuration of the circuit architecture shown in FIG. 1 in a phase Phase3 according to an embodiment of the present invention. Under the control of the multiphase configuration switching control circuit 110 shown in FIG. 1 (or the control signals {VREF_SHORT, VAUTO_FASTSET, VAUTO_FASTSET_B} generated and output thereby), the switch circuits {SW1, SW2, SW3, SW4} may operate as shown in FIG. 5A, to allow the multiphase configuration switching control circuit 110 to perform the third configuring operation on the circuit architecture of the LDO regulator 100A. For example, the multiphase configuration switching control circuit 110 may turn on the switch circuit SW4 and turn off the switch circuits SW1, SW2 and SW3.

FIG. 5B illustrates a configuration of the circuit architecture shown in FIG. 2 in the phase Phase3 according to an embodiment of the present invention. Under the control of the multiphase configuration switching control circuit 110 shown in FIG. 2 (or the control signals {VREF_SHORT, VAUTO_FASTSET, VAUTO_FASTSET_B} generated and output thereby), the switch circuits {SW1, SW2, SW3, SW4} may operate as shown in FIG. 5B, to allow the multiphase configuration switching control circuit 110 to perform the third configuring operation on the circuit architecture of the LDO regulator 100B. For example, the multiphase configuration switching control circuit 110 may turn on the switch circuit SW4 and turn off the switch circuits SW1, SW2 and SW3.

As shown in any figure among FIG. 5A and FIG. 5B, performing the third configuring operation may comprise:
(1) disabling the second dedicated current path (e.g., the current path starting from reference voltage converter 103, passing through the switch circuit SW1 and reaching the upper terminal of the capacitor C1) corresponding to the phase Phase2, where the second dedicated current path is no longer used for coupling the first input terminal (e.g., the first input terminal for receiving the input voltage VIP) of the operational amplifier 104 to the reference voltage VR2 in the phase Phase3; where after performing the second configuring operation, the multiphase configuration switching control circuit 110 may immediately perform the third configuring operation, to make the third configuring operation immediately follow the second configuring operation, but the present invention is not limited thereto.

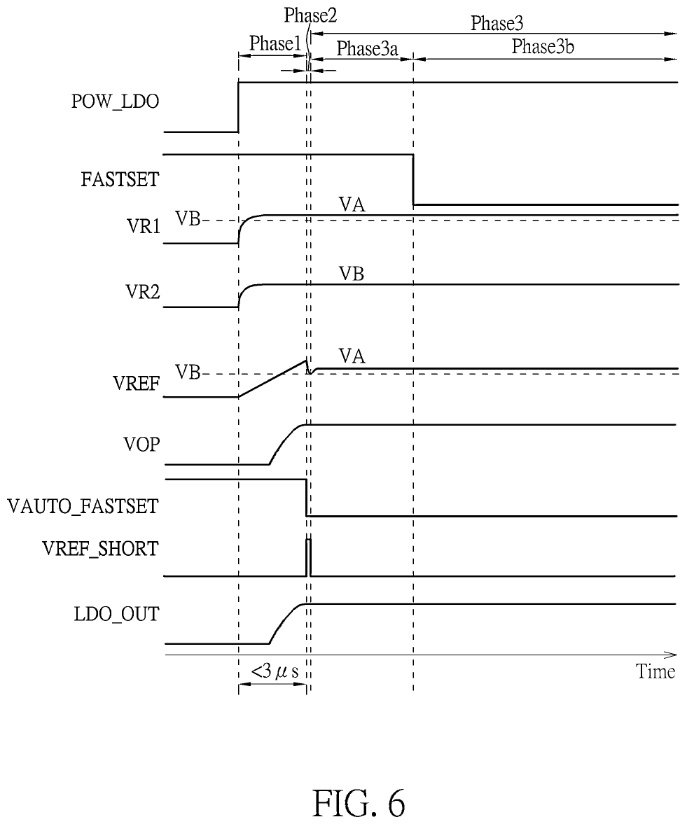

FIG. 6 illustrates a timing diagram of some associated signals such as the power control signal POW_LDO, the system control signal FASTSET, the reference voltages VR1 and VR2, the target reference voltage VREF, the output voltage VOP of the operational amplifier 104, the control signals VAUTO_FASTSET and VREF_SHORT, and the output voltage LDO_OUT of the LDO regulator according to an embodiment of the present invention, where the voltage levels VA and VB and the phases Phase1, Phase2 and Phase3 together with the sub-phases Phase3a and Phase3b of the Phase3 may be illustrated in FIG. 6 for better comprehension, but the present invention is not limited thereto. According to some embodiments, the associated signals, the voltage levels VA and VB, the phases Phase1, Phase2 and Phase3, and/or the sub-phases Phase3a and Phase3b may vary. In addition, an upper-layer circuit (e.g., at least one microcontroller or processor) in the electronic device may generate the power control signal POW_LDO to control the power of the LDO regulator (e.g., the LDO regulators 100A or 100B) of the present invention, for turning on the LDO regulator at the beginning (or start) time point of the phase Phase1 to provide the power supply voltage VDD through the power line PWR, and may generate the system control signal FASTSET to control the aforementioned at least one internal circuit to use the LDO regulator in the sub-phase Phase3b. In some embodiments, after the beginning time point of the phase Phase2, the multiphase configuration switching control circuit 110 may control the control signal VREF_SHORT to perform a corresponding state transition according to the system control signal FASTSET (or the state transition thereof), and this means that the phase Phase2 may become longer to make the phase Phase3 be equal to the sub-phase Phase3b and make the length of the sub-phase Phase3a be equal to zero, but the present invention is not limited thereto. As shown in FIG. 6, the multiphase configuration switching control circuit 110 may control the time difference between the two state transition time points of the control signal VREF_SHORT (or the respective time points of the rising edge and the falling edge thereof) to be very small, for example, by using a delay circuit controlling this time difference to be equal to a predetermined delay time (e.g., 0.3 μs).

For example, the time length of the phase Phase1 may be less than 3 μs, which is less than the time for the conventional LDO regulator to reach the steady state (for example, more than 10 μs). After performing the first configuring operation, the multiphase configuration switching control circuit 110 may use the first dedicated current path to perform the first preliminary setting operation on the target reference voltage VREF according to the power supply voltage VDD, and more particularly, use the current I on the first dedicated current path, such as a large current that is much greater than the maximum output current of the reference voltage generator 102 and much greater than the maximum output current of the reference voltage converter 103, to charge the capacitor C1 in the phase Phase1, for accelerating the target reference voltage VREF reaching the first predetermined range, for example, exceeding the voltage level VB (or in the range of the interval (VB, ∞]). In addition, after performing the second configuring operation, the multiphase configuration switching control circuit 110 may utilize the second dedicated current path to forcibly set the target reference voltage VREF to be equal to the reference voltage VR2, in particular, achieve a short circuit by turning on the switch circuit SW1 to make VREF=VR2 in the phase Phase2, for reducing any deviation of the target reference voltage VREF generated in the phase Phase1 with respect to the second predetermined range to accelerate the target reference voltage VREF reaching the second predetermined range, for example, approaching the voltage level VA. Additionally, after performing the second configuring operation, the multiphase configuration switching control circuit 110 may immediately perform the third configuring operation, and more particularly, cancel the short circuit by turning off the switch circuit SW1 to allow the current coming from the reference voltage generator 102 and passing through the resistor R1 to charge the capacitor C1 in the phase Phase3, for controlling the target reference voltage VREF to reach the second predetermined range earlier, for example, approach the voltage level VA.

The LDO regulator of the present invention (e.g., the LDO regulators 100A or 100B) can be ready for use in a very short time after being turned on, and therefore the performance thereof is better than that of the conventional LDO regulator. Regarding the conventional LDO regulator, the time difference between the transition time of the system control signal FASTSET (such as the time of its falling edge) and the transition time of the power control signal POW_LDO (such as the time of its rising edge) may need to be set as at least 20 ms to ensure that the output voltage of the conventional LDO regulator becomes stable. Regarding the LDO regulator of the present invention, this time difference can be greatly shortened. Taking the timing diagram shown in FIG. 6 as an example, the time length of the phase Phase1 can be less than 3 μs, the time length of the phase Phase2 can be much less than 3 μs, and the total time length of the phase Phase2 and the sub-phase Phase3a can be approximately equal to 4.5 μs, which means the LDO regulator of the present invention can be ready for use in 7.5 μs or less, where (3+4.5) μs=7.5 μs. As achieving the short circuit by turning on the switch circuit SW1 to make VREF=VR2 in the phase Phase2 can control the target reference voltage VREF to be very close to the voltage level VA, the target reference voltage VREF can quickly reach the voltage level VA after the short circuit is cancelled. Therefore, the time difference between the transition time of the system control signal FASTSET (such as the time of its falling edge) and the transition time of the power control signal POW_LDO (such as the time of its rising edge) can be controlled within 7.5 μs or even shorter, but the present invention is not limited thereto. When adopting more conservative control, this time difference can be arbitrarily set larger, for example, can be set as 5 ms, which is still less than the 20 ms required by the conventional LDO regulator.

In addition, in order to save area and reduce power consumption, the power consumption of the reference voltage generator in the conventional LDO regulator can be quite limited, and the associated resistance value R/capacitance value C for more stringent product specifications is usually larger and the stabilization time is correspondingly longer, which can cause the conventional LDO regulator to be unable to meet the requirements of high-speed operations. For the same stringent product specifications, the LDO regulator of the present invention can perform the multiphase configuration switching control to easily meet the requirements of high-speed operations, for example, in a situation where the maximum output current of the reference voltage generation circuit 101 (or the reference voltage generator 102 or the reference voltage converter 103 therein) may be quite limited and the resistance value R1 of the resistor R1 and/or the capacitance value C1 of the capacitor C1 may be increased and the settling time of the target reference voltage VREF may be accordingly increased. The LDO regulator can adopt the predetermined difference (VA−VB) that has been designed to be very small to make the target reference voltage VREF reach the voltage level VA immediately after quickly exceeding the voltage level VB and then immediately returning to the voltage level VB.

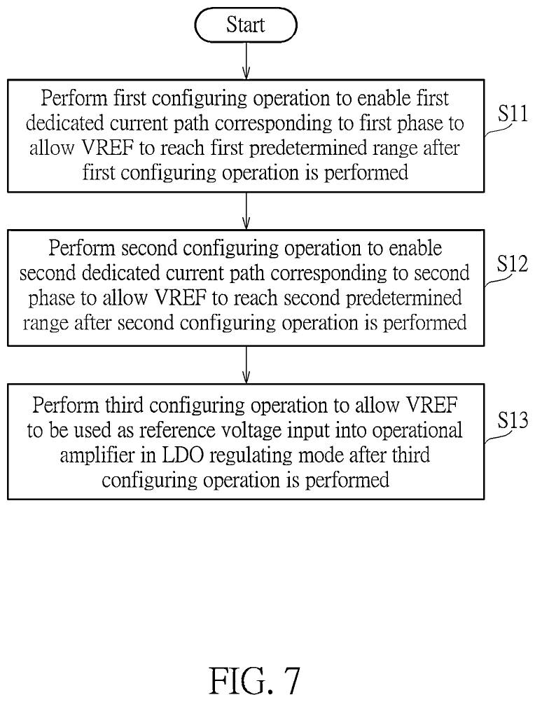

FIG. 7 illustrates a working flow of an operation method of a LDO regulator (e.g., the LDO regulators 100A or 100B) according to an embodiment of the present invention.

In Step S11, the LDO regulator may utilize the multiphase configuration switching control circuit 110 to perform the first configuring operation on the circuit architecture of the LDO regulator to enable the first dedicated current path corresponding to a first phase (e.g., the phase Phase1), to allow the target reference voltage VREF used in the LDO regulating mode to reach the first predetermined range after the first configuring operation is performed.

In Step S12, the LDO regulator may utilize the multiphase configuration switching control circuit 110 to perform the second configuring operation on the circuit architecture of the LDO regulator to enable the second dedicated current path corresponding to a second phase (e.g., the phase Phase2), to allow the target reference voltage VREF to reach the second predetermined range after the second configuring operation is performed.

In Step S13, the LDO regulator may utilize the multiphase configuration switching control circuit 110 to perform the third configuring operation on the circuit architecture of the LDO regulator, to allow the target reference voltage VREF to be used as the reference voltage VREF input into the operational amplifier 104 in the LDO regulating mode after the third configuring operation is performed.

The LDO regulator may operate according to the workflow shown in FIG. 7 to greatly improve the overall performance of the electronic device. For better comprehension, assuming that in one embodiment the LDO regulator may be configured to temporarily skip Steps S11 and/or S12, but the invention is not limited thereto. For example, in a situation where the execution of Steps S11 and S12 is skipped and the configuration shown in FIG. 5A or FIG. 5B is performed directly, it would take a long time to charge the capacitor C1 using only the current coming from the reference voltage generator 102 and passing through the resistor R1, for example, the time corresponding to the time constant(R1*C1), in order for the target reference voltage VREF to reach the voltage level VA, since the capacitor C1 may be very large (for example, for filtering out the noise). For another example, in a situation where the execution of step S11 is skipped and the configuration shown in FIG. 4A or FIG. 4B is directly performed and then the configuration shown in FIG. 5A or FIG. 5B is performed, as the maximum output current of the reference voltage generation circuit 101 (or the reference voltage generator 102 or the reference voltage converter 103 therein) is very limited, there is still the problem of requiring a long charging time. For yet another example, in a situation where the execution of step S12 is skipped and the configuration shown in FIG. 3A or FIG. 3B is first performed and then the configuration shown in FIG. 5A or FIG. 5B is performed, when the first dedicated current path corresponding to the phase Phase1 is disabled, there may be significant configuration switching reaction time, which means that the target reference voltage VREF may continue to increase significantly higher than the voltage level VA, so additional time is required for the target reference voltage VREF to reach the voltage level VA. As shown in FIG. 7, in a situation where the configuration shown in FIG. 3A or FIG. 3B, the configuration shown in FIG. 4A or FIG. 4B and the configuration shown in FIG. 5A or FIG. 5B are subsequently performed, the LDO regulator can immediate achieve the steady state without any issues. For brevity, similar descriptions for this embodiment are not repeated in detail here.

For better comprehension, the method may be illustrated with the working flow shown in FIG. 7, but the present invention is not limited thereto. According to some embodiments, one or more steps may be added, deleted, or changed in the working flow shown in FIG. 7. For example, in the phase Phase1, the state transition of the output voltage VOP of the operational amplifier 104 may indicate VREF>VR2, and the control signal AF may transit correspondingly with the state transition of the output voltage VOP, which means that the state transition of the control signal AF may indicate VREF>VR2. The multiphase configuration switching control circuit 110 may control other control signals such as the control signals VREF_SHORT, VAUTO_FASTSET and VAUTO_FASTSET_B to correspondingly transit at the beginning time point of the phase Phase2 according to the state transition of the control signal AF, to start performing the second configuring operation to set VREF=VR2. In addition, the automatic fast-set control circuit 120 may utilize the control signal AF to control the current control circuit 130, and more particularly, control the current control circuit 130 to stop outputting the current I when detecting VREF>VR2. For example, in a situation where overheating does not occur, the current control circuit 130 may be implemented by way of a single transistor (e.g., a MOSFET) coupled between the power line PWR and the switching circuit SW3 or multiple transistors (e.g., multiple MOSFETs) connected in parallel, for acting as a switch for the current I and selectively outputting the current I according to the control signal AF, where the switch circuit SW3 may be arranged to prevent any influence of the current control circuit 130 in Steps S12 and S13. Additionally, the operational amplifier 104 may operate according to a biasing source BIAS (e.g., a current source or a voltage source). For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A low-dropout (LDO) regulator, comprising:
a reference voltage generation circuit, arranged to generate at least one reference voltage;
an operational amplifier, coupled to the reference voltage generation circuit, arranged to control an output voltage of the LDO regulator via negative feedback in a LDO regulating mode of the LDO regulator;
a transistor, coupled to the operational amplifier, arranged to generate the output voltage of the LDO regulator under control of the operational amplifier in the LDO regulating mode, for further use; and
a multiphase configuration switching control circuit, coupled to the reference voltage generation circuit, the operational amplifier and the transistor, arranged to perform multiphase configuration switching control to perform multiple configuring operations on circuit architecture of the LDO regulator;
wherein:
the multiphase configuration switching control circuit performs a first configuring operation on the circuit architecture of the LDO regulator to enable a first dedicated current path corresponding to a first phase, to allow a target reference voltage used in the LDO regulating mode to reach a first predetermined range after the first configuring operation is performed;
the multiphase configuration switching control circuit performs a second configuring operation on the circuit architecture of the LDO regulator to enable a second dedicated current path corresponding to a second phase, to allow the target reference voltage to reach a second predetermined range after the second configuring operation is performed; and
the multiphase configuration switching control circuit performs a third configuring operation on the circuit architecture of the LDO regulator, to allow the target reference voltage to be used as a reference voltage input into the operational amplifier in the LDO regulating mode after the third configuring operation is performed.

2. The LDO regulator of claim 1, wherein reaching the first predetermined range comprises exceeding a second voltage level, and reaching the second predetermined range comprises approaching a first voltage level, wherein the second voltage level is less than the first voltage level.

3. The LDO regulator of claim 2, wherein the at least one reference voltage comprises a first reference voltage equal to the first voltage level and a second reference voltage equal to the second voltage level.

4. The LDO regulator of claim 1, wherein performing the first configuring operation comprises:
enabling the first dedicated current path corresponding to the first phase to perform a first preliminary setting operation on the target reference voltage according to a power supply voltage, for accelerating the target reference voltage reaching the first predetermined range.

5. The LDO regulator of claim 4, wherein reaching the first predetermined range comprises exceeding a second voltage level, and the at least one reference voltage comprises a second reference voltage equal to the second voltage level; and performing the first configuring operation further comprises:
coupling multiple input terminals of the operational amplifier to the target reference voltage and the second reference voltage, respectively, to make the operational amplifier act as a comparator, for comparing the target reference voltage and the second reference voltage;
wherein the LDO regulator further comprises:
an automatic fast-set control circuit, coupled to an output terminal of the operational amplifier, arranged to receive a comparison result of the target reference voltage and the second reference voltage from the operational amplifier, to generate a control signal according to the comparison result; and
a current control circuit, coupled to the automatic fast-set control circuit, arranged to control a current on the first dedicated current path according to the control signal, for accelerating the target reference voltage reaching the first predetermined range.

6. The LDO regulator of claim 1, wherein reaching the first predetermined range comprises exceeding a second voltage level, and the at least one reference voltage comprises a second reference voltage equal to the second voltage level; and performing the first configuring operation comprises:
coupling a first input terminal and a second input terminal of the operational amplifier to the target reference voltage and the second reference voltage, respectively, to make the operational amplifier act as a comparator, for comparing the target reference voltage and the second reference voltage.

7. The LDO regulator of claim 6, wherein performing the first configuring operation further comprises:
disconnecting a negative feedback path between the second input terminal of the operational amplifier and a first terminal of the transistor to disable the negative feedback path used in the LDO regulating mode, wherein in the LDO regulating mode, the first terminal of the transistor is arranged to output the output voltage of the LDO regulator.

8. The LDO regulator of claim 6, wherein performing the second configuring operation further comprises:
stopping coupling the second input terminal of the operational amplifier to the second reference voltage, and coupling the second input terminal of the operational amplifier to a first terminal of the transistor, to enable a negative feedback path used in the LDO regulating mode, wherein in the LDO regulating mode, the first terminal of the transistor is arranged to output the output voltage of the LDO regulator;
disabling the first dedicated current path corresponding to the first phase, wherein the first dedicated current path is coupled between a power line and the first input terminal of the operational amplifier in the first phase, and is no longer coupled between the power line and the first input terminal of the operational amplifier in the second phase; and
enabling the second dedicated current path corresponding to the second phase to make the first input terminal of the operational amplifier be coupled to the second reference voltage, to forcibly set the target reference voltage to be equal to the second reference voltage, for reducing any deviation of the target reference voltage generated in the first phase with respect to the second predetermined range to accelerate the target reference voltage reaching the second predetermined range.

9. The LDO regulator of claim 8, wherein performing the third configuring operation further comprises:
disabling the second dedicated current path corresponding to the second phase, wherein the second dedicated current path is no longer used for coupling the first input terminal of the operational amplifier to the second reference voltage in a third phase.

10. An operation method applicable to the LDO regulator of claim 1, the operation method comprising:
utilizing the multiphase configuration switching control circuit to perform the first configuring operation on the circuit architecture of the LDO regulator to enable the first dedicated current path corresponding to the first phase, to allow a target reference voltage used in the LDO regulating mode to reach the first predetermined range after the first configuring operation is performed;
utilizing the multiphase configuration switching control circuit to perform the second configuring operation on the circuit architecture of the LDO regulator to enable the second dedicated current path corresponding to the second phase, to allow the target reference voltage to reach the second predetermined range after the second configuring operation is performed; and
utilizing the multiphase configuration switching control circuit to perform the third configuring operation on the circuit architecture of the LDO regulator, to allow the target reference voltage to be used as the reference voltage input into the operational amplifier in the LDO regulating mode after the third configuring operation is performed.
